(19) United States
(12) Patent Application Publication
(10) Pub. No.: US 2002/0175919 A1
(43) Pub. Date: Nov. 28, 2002

(54) Graphic accelerator

(75) Inventor: Hiroshi Kuranaga, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo, JP

(21) Appl. No.: 09/968,518

(22) Filed: Oct. 2, 2001

(30) Foreign Application Priority Data
May 22, 2001 (JP) 2001-152815

(51) Int. Cl. G06F 15/16

(52) U.S. Cl. 345/539

(57) ABSTRACT

In the graphic accelerator, control section reads pixel data of 1 word among pixel data in the S and D areas and makes the S and D buffers respectively store the resulting data. Furthermore, the data pass section transfers the pixel data of the S buffer to the first WRT buffer, transfers the pixel data of the D buffer to the second WRT buffer. The pixel data in the second WRT buffer is written in the corresponding S area, and the pixel data in the first WRT buffer is written in the corresponding D area.

### FIELD OF THE INVENTION

The present invention relates to a graphic accelerator for carrying out a bit-block transfer process such as an exchange for image areas at high speed.

### BACKGROUND OF THE INVENTION

FIG. 7 shows a block diagram of a bit-block transfer device in a conventional two-dimensional graphic accelerator. This bit block transfer device has a source area and a destination area. This bit block transfer device is constituted by a memory 10 for storing pixel data in these areas, a source buffer (“S buffer”) 30 for holding pixel data read from a source area of the memory 10 through a memory interface (“memory IF”) 20, a destination buffer (“D buffer”) 40 for holding pixel data read from the destination area of the memory 10 through the memory IF20, a write buffer (“WRT buffer”) 50 for holding data to be written to the memory 10, a data pass section 60 for transferring data read from the S buffer 30 or the D buffer 40 to the buffer WRT 50, for calculating the data read from the buffer 30, 40, and for transferring the results of the calculation to the WRT buffer 50, a plotting data generation section (“DRAW data generation section”) 70 for generating plotting data to be plotted, an address signal generation section 80 for generating an address signal indicating an address in an area to be accessed within each of the source area and the destination area and for transferring the resulting signal to a control section 90, and the control section 90 for controlling the respective constituent elements.

It is assumed that the S buffer 30, D buffer 40 and WRT buffer 50 have an access unit (word) of 32 bits (one word). Moreover, if the pixel data has 8 bits and the access unit (word) to the memory 10 has 32 bits, pixel data corresponding to 4 pixels per one word is stored in the memory 10.

The address signal generation section 80 is provided with a plotting data register for storing the generated plotting data (hereinafter, referred to as DRAW data). In the following description, the plotting data register is referred to as a DRAW data register. Based upon the address signal from the address signal generation section 80 received through the memory IF 20, the control section 90 executes an access to the memory 10. For example, it reads pixel data from the S area and D area, and executes processes such as a writing process on the D area.

In such a graphic accelerator, respective bit-block transfer processes, such as “COPY”, “DRAW”, “MIX”, “DRAW with Operation”, “SWAP”, “DRAW, MIX and DRAW with Operation with D area data being saved” and “MIX &MIX”, can be executed.

The bit-block transfer processes will now be explained. FIG. 8A to FIG. 8D explain the respective bit block transfer processes when an S area and a D area are placed on one sheet of graphic plane 11 that is allocated to the memory 10.

(1) COPY

As shown in FIG. 8A, “COPY” is a bit-block transfer process for writing pixel data in the S area onto the D area. Inthis process, more specifically, the following three steps (1) to (3) are repeated until data to be copied has no longer existed.

(1) The control section 90 reads pixel data of 1 word among pixel data within the S area, and allows the S buffer 30 to store the resulting data.

(2) The data pass section 60 transfers the pixel data of the S buffer 30 to the WRT buffer 50.

(3) The control section 90 writes the pixel data of the WRT buffer 50 in the corresponding D area.

In this case, since a period of approximately 10 clocks (time) is required for each step, a period of 30 clocks is required to execute the COPY process of 1 word.

FIG. 9 shows a case in which pixel data in the S area consisting of 36 (12×3) pixels placed on the graphic plane 11 constituted by 400 (20×20) pixels is written in the D area.

In “COPY 1”, a COPY process is carried out from the S area to the D area 1 having a shift from the S area with 5 lines downward and 4 pixels to the right, and the lateral positional offset between the S area and the D area 1 is set to an integer multiple of 1 word (in this case, one). In this case, first, the control section 90 reads pixels located on the respective pixel addresses of “0, 1, 2, 3” within the S area on the memory 10, and allows the S buffer 30 to store the resulting pixel data. The data pass section 60 transfers 4 pixel data (pixel data of 1 word) of the S buffer 30, as it is, to the WRT buffer 50. The control section 90 writes the 4 pixel data of the WRT buffer 50 in the respective addresses “0, 1, 2, 3” of the D area 1 on the memory 10.

Moreover, “COPY 2” is a COPY process of the S area to the D area 2 having a shift from the S area with 10 lines downward and 2 pixels to the right, and the lateral positional offset between the S area and the D area 2 is not an integer multiple of 1 word (4 pixels). In this case, the data pass section 60 shifts the pixel data (that is, 4 pixel data) of the S buffer 30 by two pixels, and transfers the resulting data to the WRT buffer 50.

Bit block transfer process, when the lateral positional offset between the S area and the D area is set to an integer multiple of 1 word, will now be explained. In the case when the positional offset is not an integer multiple of 1 word, the data shift process is added in the data pass section 60 in the same manner as described above.

Next, bit-block transfer processes will be explained while referring to FIG. 8A to FIG. 8D.

(2) DRAW

As illustrated in FIG. 8B, this DRAW process is a bit-block transfer process for painting the D area with DRAW data. In this process, more specifically, the following two steps (1) and (2) are repeated.

(1) The data pass section 60 reads DRAW data from the DRAW data register storing the DRAW data generated by the DRAW data generation section 70, and transfers the resulting data to the WRT buffer 50.

(2) The control section 90 writes the pixel data of the WRT buffer 50 in the corresponding D area.

In this case, since a period of approximately 10 clocks (time) is required for each step, a period of 20 clocks is required to execute the DRAW process of 1 word.

(3) Mix

As illustrated in FIG. 8C, this MIX process is a bit-block transfer process in which pixel data of the S area and pixel data of the D area are subjected to operations (AND (logical product), OR (logical add), NOR (negative OR), etc.) and the results of the operations are written in the D area. In this process, more specifically, the following four steps (1) to (4) are repeated until data to be subjected to the MIX process has no longer existed.

(1) The control section 90 reads pixel data of 1 word among pixel data 1 within the S area, and allows the S buffer 30 to store the resulting data.

(2) The control section 90 reads pixel data of 1 word among pixel data 2 within the D area, and allows the D buffer 40 to store the resulting data.

(3) The data pass section 60 carries out operations on the pixel data of the S buffer 30 and the pixel data of the D buffer 40 every corresponding pixel, and transfers the results of the operations to the WRT buffer 50.

(4) The control section 90 writes the pixel data of the WRT buffer 50 in the corresponding D area.

In this case, since a period of approximately 10 clocks (time) is required for each step, a period of 40 clocks is required to execute the MIX process of 1 word.

(4) DRAW with Operation

As illustrated in FIG. 8D, this “DRAW with Operation” process is a bit-block transfer process in which DRAW data and pixel data of the D area are subjected to operations (AND, OR, NOR, etc.) and the results of the operations are written in the D area. The DRAW data is used for painting the D area constituted by longitudinal lines and lateral lines indicated by a dotted line in FIG. 8D. In this process, more specifically, the following three steps (1) to (3) are repeated until data to be subjected to the “DRAW with Operation” process has no longer existed.

(1) The control section 90 reads pixel data of 1 word among pixel data within the D area, and allows the D buffer 40 to store the resulting data.

(2) The data pass section 60 reads DRAW data from the DRAW data register in the DRAW data generation section 70, and subjects the DRAW data thus read and the pixel data of the D buffer 40 to operation processes every corresponding pixel, and transfers the results of the operations to the WRT buffer 50.

(3) The control section 90 writes the pixel data of the WRT buffer 50 in the corresponding D area.

In this case, since a period of approximately 10 clocks (time) is required for each step, a period of 30 clocks is required to execute the “DRAW with Operation” process of 1 word.

(5) SWAP

This SWAP process is a bit-block transfer process for swapping (exchange of pixel data) the pixel data of the S area and the pixel data of the D area. This process is carried out in the following manner.

(1) Pixel data in the D area is copied onto a work area assigned to the memory 10.

(2) The pixel data in the S area is copied onto the D area.

(3) The pixel data in the work area is copied onto the S area.

As described above, the SWAP process requires COPY processes three times, each requiring a processing time of 30 clocks; therefore, it requires not only 90 clocks to execute the SWAP process of 1 word, but also a work area having the same size as the S area (or the D area) on the memory 10.

(6) DRAW, MIX and DRAW with Operation with D area Data Being Saved

In these “DRAW, MIX and DRAW with Operation with D area data being saved” processes, bit-block transfer processes for saving the pixel data of the D area in the work area are carried out. In the above-mentioned respective processes of “DRAW, MIX and DRAW with Operation”, the pixel data in the D area is erased; therefore, this bit-block transfer process is adopted when it is necessary to save the pixel data in the work area on the memory 10. In this case, the COPY process is required prior to each of the processes, and the COPY process requires 30 clocks per one word.

For this reason, when the pixel data of the D area is saved in the work area, the number of clocks per 1 word is represented by COPY=30 clocks plus the number of clocks in each of the above-mentioned processes, that is, DRAW=20 clocks, MIX=40 clocks and DRAW with Operation=30 clocks. In other words, in the case of DRAW, 50 clocks are required, in the case of MIX, 70 clocks are required, and in the case of DRAW with Operation, 60 clocks are required.

(7) MIX & MIX

This MIX & MIX process is a bit-block transfer process in which two types of operations (AND, OR, NOR, etc.) are carried out by using the pixel data of the S area and the pixel data of the D area and the results of the operations are written in the S area and the D area. This process is carried out in the following manner.

(1) The pixel data of the D area is copied onto the work area.

(2) The MIX process is executed by using the pixel data of the S area and the pixel data of the D area. In this case, the pixel data that has been subjected to the MIX process is written in the D area.

(3) The work area is set to the S area, while the S area is set to the D area, and the MIX process is executed by using the pixel data in these areas. In this case, the pixel data that has been subjected to the MIX process is written in the D area (that is, the S area).

As described above, one time of the COPY process requiring a processing time of 30 clocks and two times of the MIX processes, each requiring a process time of 40 clocks, are required; therefore, the MIX & MIX process of 1 word requires 110 clocks, thereby requiring a long time. Moreover, a work area is also required on the memory 10.

In a bit-block transfer device in a conventional two-dimensional graphic accelerator, the following numbers of clocks are required for executing the SWAP process of 1 word, each of the “DRAW, MIX and DRAW with Operation with D area data being saved” processes of 1 word and the MIX & MIX process of 1 word.

That is,

SWAP process=90 clocks

DRAW with D area data being saved=50 clocks

MIX with D area data being saved=70 clocks

DRAW with Operation with D area data being saved=60 clocks

MIX & MIX=110 clocks

From the viewpoint of accelerating the image processing, there have been demands for a graphic accelerator having a bit-block transfer device which can carry out bit-block transfer processes in a processing time shorter than the processing time of each of the above-mentioned bit-block transfer processes. However, at present, such a graphic accelerator has not been achieved.

Moreover, the bit-block transfer device of the above-mentioned two-dimensional graphic accelerator requires a work area having the same size as the S area (or the D area) on the memory 10 in the SWAP process of 1 word, and in the MIX & MIX process of 1 word, it also requires a work area on the memory 10, with the result that it is not possible to effectively use the memory.

### SUMMARY OF THE INVENTION

It is an object of this invention to provide a graphic accelerator which makes it possible to improve the processing speed of the bit-block transfer process, and also to effectively use the memory.

The graphic accelerator according to the present invention is provided with a memory having a source area and a destination area; a first buffer which holds pixel data read from the source area of the memory; a second buffer which holds pixel data read from the destination area of the memory; a third buffer which holds pixel data to be written into the memory; a fourth buffer which holds pixel data to be written into the memory; a reading unit which reads pixel data from the source area of the memory and makes the first buffer store the read pixel data, reads pixel data from the destination area of the memory makes the and makes second buffer store the read pixel data, in a unit of access to the memory; a transfer unit which makes the first buffer to transfer the pixel data held in the first buffer to the third buffer, and makes the second buffer to transfer the pixel data held in the second buffer to the fourth buffer; and a writing unit which writes the pixel data held in the fourth buffer in the source area of the memory and writes the pixel data held in the third buffer in the destination area of the memory.

Thus, the pixel data within the source area is transferred to the third buffer, and the pixel data within the destination area is transferred to the fourth buffer. Then, the pixel data within the third buffer is written in the destination area, and the pixel data within the fourth buffer is written in the source area.

Other objects and features of this invention will become apparent from the following description with reference to the accompanying drawings.

### BRIEF DESCRIPTION OF THE DRAWINGS

FIG. 1 is a block diagram that shows a construction of a graphic accelerator in accordance with a first embodiment of the present invention;

FIG. 2 is a block diagram that shows a construction of a graphic accelerator in accordance with a second embodiment of the present invention;

FIG. 3 is a block diagram that shows a construction of a graphic accelerator in accordance with a third embodiment of the present invention;

FIG. 4 is a block diagram that shows a construction of a graphic accelerator in accordance with a fourth embodiment of the present invention;

FIG. 5 is a block diagram that shows a construction of a graphic accelerator in accordance with a fifth embodiment of the present invention;

FIG. 6 is a drawing that shows a bit-block transfer process of a graphic accelerator in accordance with a sixth embodiment of the present invention;

FIG. 7 is a block diagram that shows a construction of a conventional graphic accelerator;

FIG. 8A to FIG. 8D are drawings that explains a bit-block transfer process of the conventional graphic accelerator; and

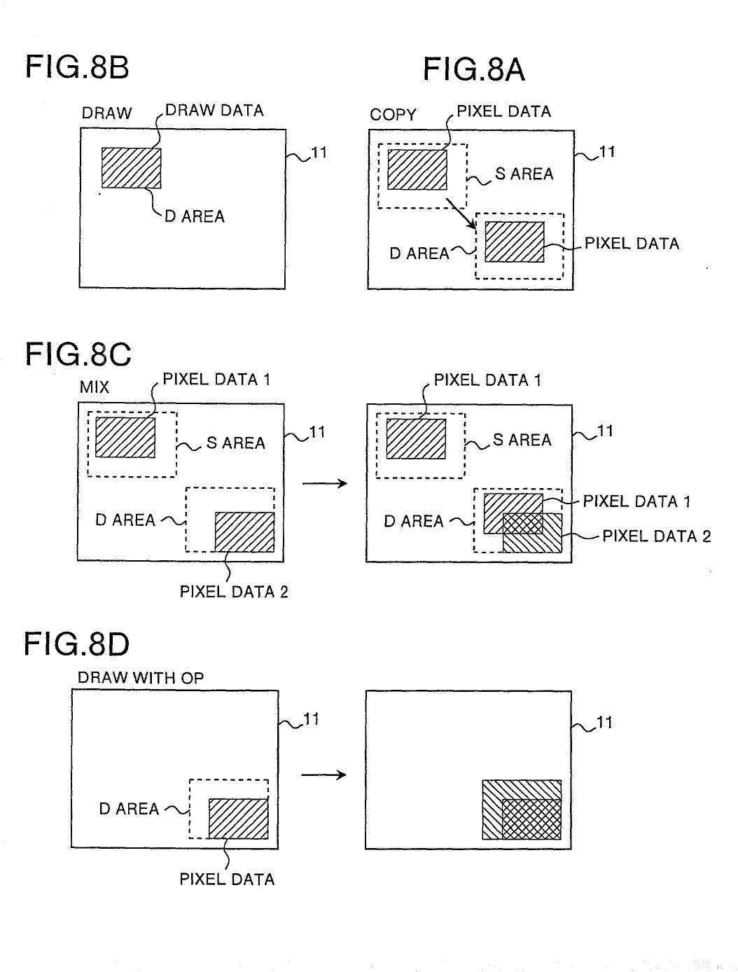

FIG. 9 is a drawing that explains a bit-block transfer process of the conventional graphic accelerator.

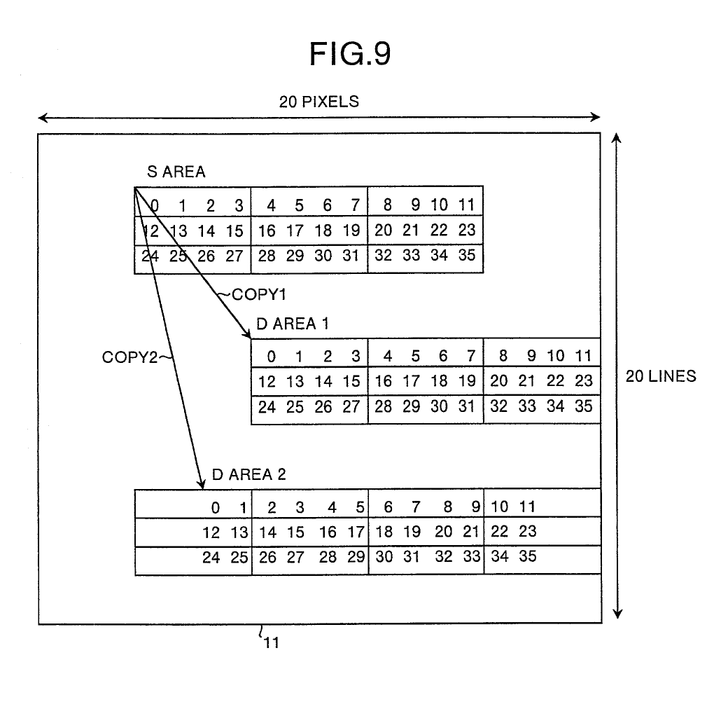

### DESCRIPTION OF THE PREFERRED EMBODIMENTS

Embodiments of the graphic accelerator in accordance with the present invention will be explained in detail below while referring to the accompanying drawings.

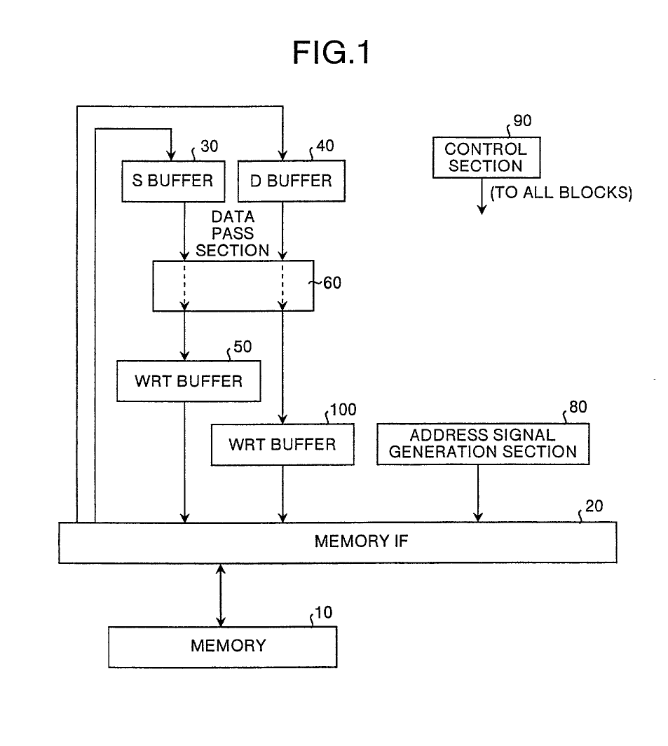

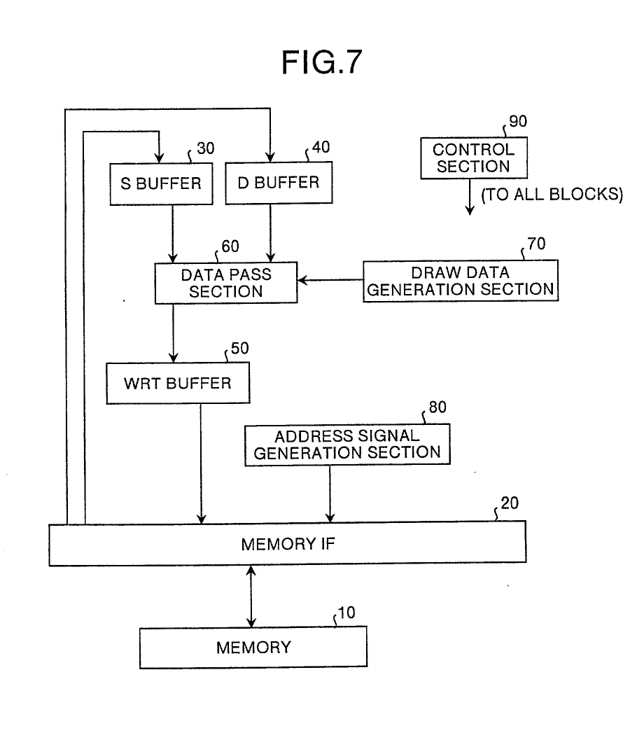

FIG. 1 is a block diagram that shows the construction of a graphic accelerator in accordance with a first embodiment of the present invention. The graphic accelerator shown in FIG. 1 has an arrangement in which the DRAW data generation section 70 is eliminated from the conventional graphic accelerator shown in FIG. 7 and a WRT buffer 100 is added thereto. In FIG. 1, those elements having the same functions as those shown in FIG. 7 are represented by the same reference numbers.

The WRT buffer 100, which holds writing data to the memory 10, is designed to hold pixel data from the D buffer 40. The first embodiment assumes a graphic accelerator for carrying out a bit-block transfer process for SWAP (exchange of pixel data).

Bit-block transfer process for SWAP by the graphic accelerator according to the first embodiment will now be explained. In the SWAP process in the first embodiment, more specifically, the following five steps (1) to (5) are repeated until data to be copied has no longer existed.

(1) The control section 90 reads pixel data of 1 word among pixel data within the S area, and allows the S buffer 30 to store the resulting data.

(2) The control section 90 reads pixel data of 1 word among pixel data within the D area, and allows the D buffer 40 to store the resulting data.

(3) The data pass section 60 transfers the pixel data of the S buffer 30 to the WRT buffer 50, and also transfers the pixel data of the D buffer 40 to the WRT buffer 100.

(4) The control section 90 writes the pixel data of the WRT buffer 100 in the corresponding S area.

(5) The control section 90 writes the pixel data of the WRT buffer 50 in the corresponding D area.

In this case, since a period of approximately 10 clocks (time) is required for each step, a period of 50 clocks is required to execute the “SWAP” process of 1 word.

As described above, in accordance with the first embodiment, the bit-block transfer process for SWAP of 1 word, which has required 90 clocks in the above-mentioned conventional device, is reduced to 50 clocks. As a result, it becomes possible to improve the processing speed of the bit-block transfer process in comparison with the above-mentioned conventional graphic accelerator. Moreover, since it does not require the work area on the memory 10 that has been required by the conventional device, it becomes possible to effectively utilize the memory 10 correspondingly.

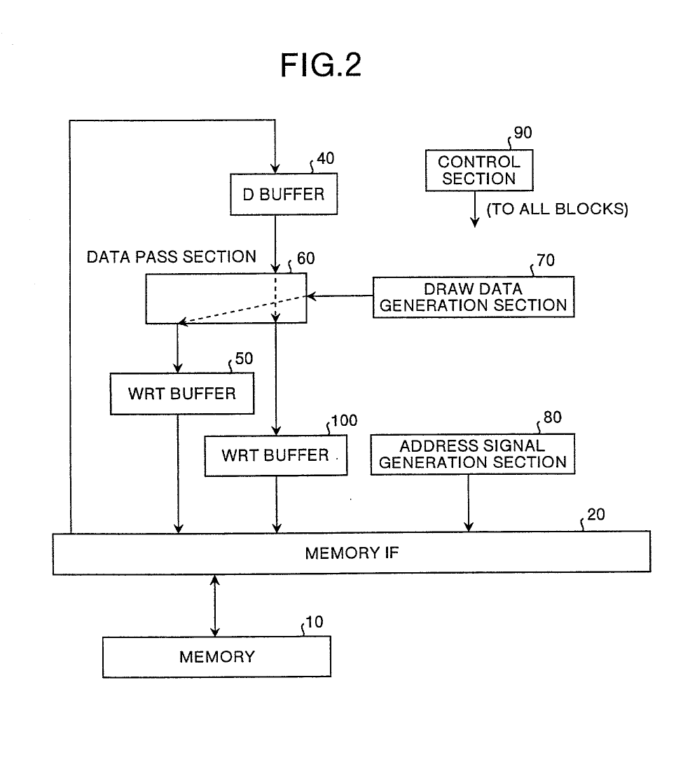

The graphic accelerator according to a second embodiment of the present invention will now be explained. FIG. 2 is a block diagram that shows the construction of a graphic accelerator in accordance with the second embodiment of the present invention.

The graphic accelerator shown in FIG. 2 has an arrangement in which the S buffer 30 is eliminated from the conventional graphic accelerator shown in FIG. 7 and a WRT buffer 100 is added thereto. In FIG. 2, those elements having the same functions as those shown in FIG. 7 are represented by the same reference numbers.

The WRT buffer 100 has the same function as the WRT buffer 100 shown in the first embodiment. The second embodiment assumes a graphic accelerator for carrying out a bit-block transfer process for “DRAW with the D area data being saved”.

In this “DRAW with the D area data being saved”, a bit-block transfer process for painting the D area with DRAW data is carried out with the pixel data of the D area being saved in the S area.

Next, an explanation will be given of the bit-block transfer process for “DRAW with the D area data being saved” by the graphic accelerator according to the second embodiment. In this process, more specifically, the following four steps (1) to (4) are repeated.

(1) The control section 90 reads pixel data of 1 word among pixel data within the D area, and allows the D buffer 40 to store the resulting data.

(2) The data pass section 60 transfers DRAW data read from the DRAW data register in the DRAW data generation section 70 to the WRT buffer 50, and also transfers the pixel data of the D buffer 40 to the WRT buffer 100.

(3) The control section 90 writes the pixel data of the WRT buffer 50 in the corresponding D area.

(4) The control section 90 writes the pixel data of the WRT buffer 100 in the corresponding S area.

In this case, since a period of approximately 10 clocks (time) is required for each step, a period of 40 clocks is required to execute the “DRAW with the D area data being saved” process of 1 word.

As described above, in accordance with the second embodiment, the bit-block transfer process for “DRAW with the D area data being saved” of 1 word, which has required 50 clocks in the above-mentioned conventional device, is reduced to 40 clocks, thereby making it possible to improve the processing speed of the bit-block transfer process, as compared with the above-mentioned conventional device.

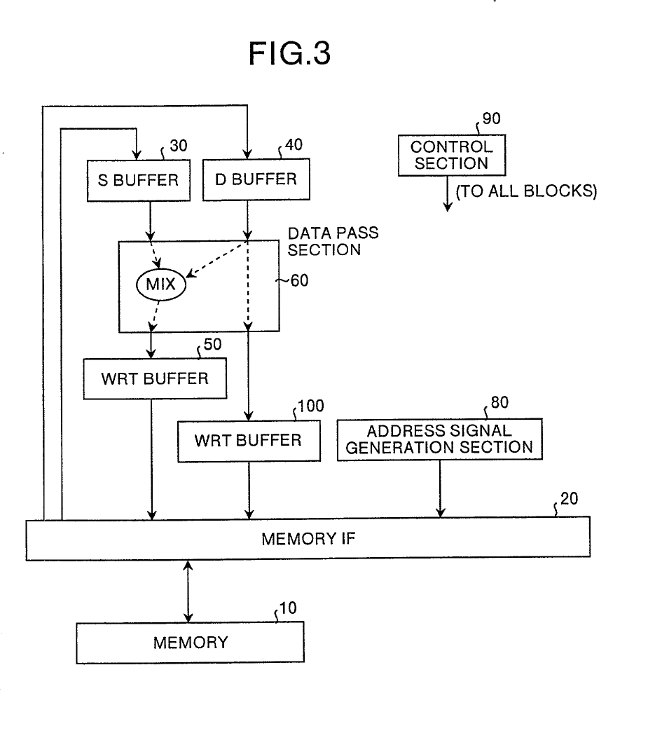

The graphic accelerator according to a third embodiment of the present invention will now be explained. FIG. 3 is a block diagram that shows the construction of a graphic accelerator in accordance with the third embodiment of the present invention.

The graphic accelerator shown in FIG. 3 basically has the same arrangement as the first embodiment shown in FIG. 1. However, different from the first embodiment, the data pass section 60 also has a MIX operation function.

The third embodiment assumes a graphic accelerator for carrying out a bit-block transfer process for “MIX with the D area data being saved”. Here, the process for “MIX with the D area data being saved” is a bit-block transfer process in which the pixel data of the S area and the pixel data of the D area are subjected to operations (AND, OR, NOR, etc.), with the pixel data of the D area being saved in the S area, and the results of the operations are written in the D area.

Next, an explanation will be given of the bit-block transfer process for “MIX with the D area data being saved” by the graphic accelerator according to the third embodiment. In this process, more specifically, the following five steps (1) to (5) are repeated, until data to be subjected to the MIX process has no longer existed.

(1) The control section 90 reads pixel data of 1 word among pixel data within the S area, and allows the S buffer 30 to store the resulting data.

(2) The control section 90 reads pixel data of 1 word among pixel data within the D area, and allows the D buffer 40 to store the resulting data.

(3) The data pass section 60 subjects the pixel data of the S buffer 30 and the pixel data of the D buffer 40 to operations every corresponding pixel, and transfers the results of the operations to the WRT buffer 50, and also transfers the pixel data of the D buffer 40 to the WRT buffer 100.

(4) The control section 90 writes the pixel data of the WRT buffer 50 in the corresponding D area.

(5) The control section 90 writes the pixel data of the WRT buffer 100 in the corresponding S area.

In this case, since a period of approximately 10 clocks (time) is required for each step, a period of 50 clocks is required to execute the “MIX with the D area data being saved” process of 1 word.

As described above, in accordance with the third embodiment, the bit-block transfer process for “MIX with the D area data being saved” of 1 word, which has required 70 clocks in the above-mentioned conventional device, is reduced to 50 clocks, thereby making it possible to improve the processing speed of the bit-block transfer process, as compared with the above-mentioned conventional device.

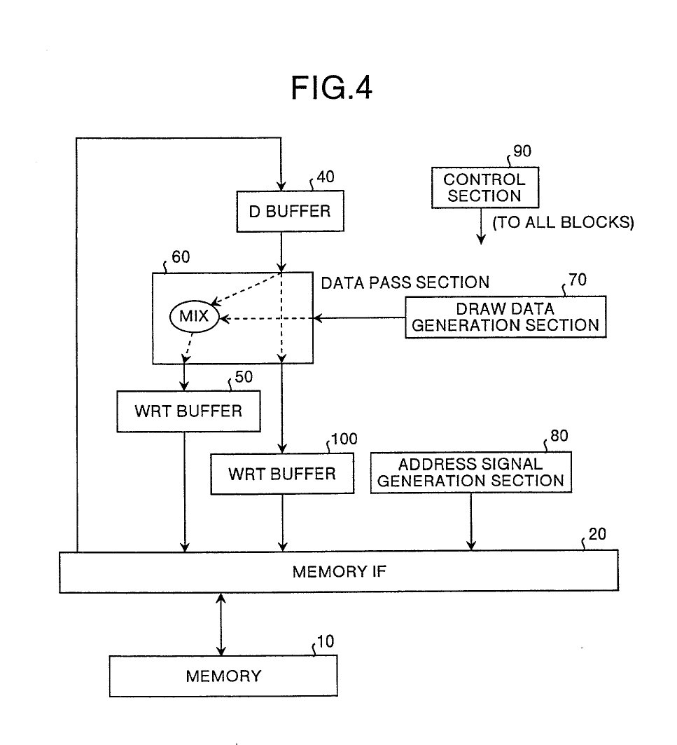

The graphic accelerator according to a fourth embodiment of the present invention will now be explained. FIG. 4 is a block diagram that shows the construction of a graphic accelerator in accordance with the fourth embodiment of the present invention.

The graphic accelerator shown in FIG. 4 basically has the same arrangement as the first embodiment shown in FIG. 2. However, different from the second embodiment, the data pass section 60 also has a MIX operation function.

The fourth embodiment assumes a graphic accelerator for carrying out a bit-block transfer process for “DRAW with Operation with the D area data being saved”.

Here, the process for “DRAW with Operation with the D area data being saved” is a bit-block transfer process in which the DRAW data of the DRAW data register in the DRAW data generation section 70 and the pixel data of the D area are subjected to operations (AND, OR, NOR, etc.), with the pixel data of the D area being saved in the S area, and the results of the operations are written in the D area.

Next, an explanation will be given of the bit-block transfer process for “DRAW with Operation with the D area data being saved” by the graphic accelerator according to the fourth embodiment. In this process, more specifically, the following four steps (1) to (4) are repeated.

(1) The control section 90 reads pixel data of 1 word among pixel data within the D area, and allows the D buffer 40 to store the resulting data.

(2) The data pass section 60 subjects the DRAW data read from the DRAW data register in the DRAW data generation section 70 and the pixel data of the D buffer 40 to operations every corresponding pixel, and transfers the results of the operations to the WRT buffer 50.

(3) The control section 90 writes the pixel data of the WRT buffer 50 in the corresponding D area.

(4) The control section 90 writes the pixel data of the WRT buffer 100 in the corresponding S area.

In this case, since a period of approximately 10 clocks (time) is required for each step, a period of 40 clocks is required to execute the “DRAW with Operation with the D area data being saved” process of 1 word.

As described above, in accordance with the fourth embodiment, the bit-block transfer process for “DRAW with Operation with the D area data being saved” of 1 word, which has required 60 clocks in the above-mentioned conventional device, is reduced to 40 clocks, thereby making it possible to improve the processing speed of the bit-block transfer process, as compared with the above-mentioned conventional device.

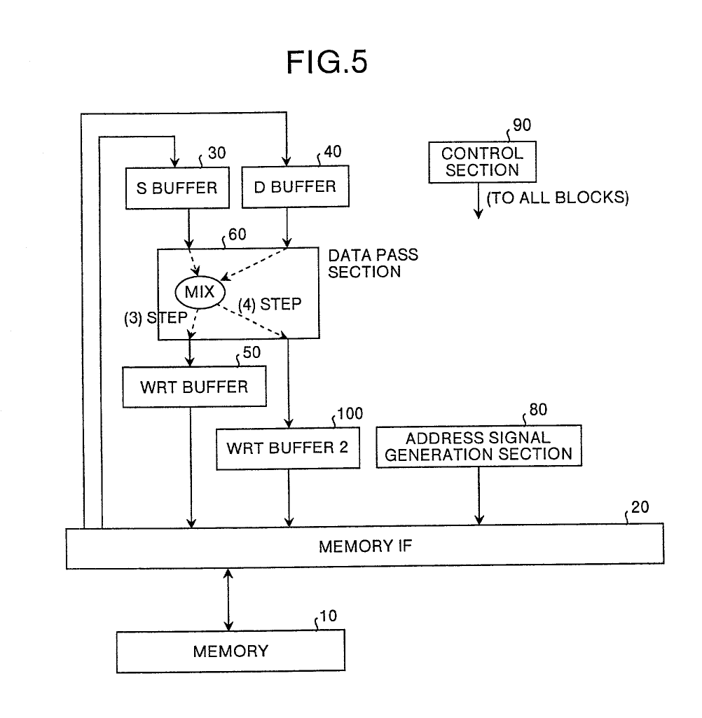

The graphic accelerator according to a fifth embodiment of the present invention will now be explained. FIG. 5 is a block diagram that shows the construction of a graphic accelerator in accordance with the fifth embodiment of the present invention. The graphic accelerator shown in FIG. 5 has the same arrangement as the third embodiment shown in FIG. 3. However, the fifth embodiment assumes a graphic accelerator for carrying out a bit-block transfer process for MIX & MIX.

The process for MIX & MIX is a bit-block transfer process in which two kinds of operations (AND, OR, NOR, etc.) are executed by using the pixel data of the S area and the pixel data of the D area, and the results of the operations are written in the S area and the D area.

Next, an explanation will be given of the bit-block transfer process for MIX & MIX by the graphic accelerator according to the fifth embodiment. In this process, more specifically, the following six steps (1) to (6) are repeated, until data to be subjected to the MIX process has no longer existed.

(1) The control section 90 reads pixel data of 1 word among pixel data within the S area, and allows the S buffer 30 to store the resulting data.

(2) The control section 90 reads pixel data of 1 word among pixel data within the D area, and allows the D buffer 40 to store the resulting data.

(3) The data pass section 60 subjects the pixel data of the S buffer 30 and the pixel data of the D buffer 40 to operations (first MIX operations) every corresponding pixel, and transfers the results of the operations to the WRT buffer 50.

(4) The data pass section 60 subjects the pixel data of the S buffer 30 and the pixel data of the D buffer 40 to operations (second MIX operations) every corresponding pixel, and transfers the results of the operations to the WRT buffer 100.

(5) The control section 90 writes the pixel data of the WRT buffer 50 in the corresponding D area.

(6) The control section 90 writes the pixel data of the WRT buffer 100 in the corresponding S area.

In this case, since a period of approximately 10 clocks (time) is required for each step, a period of 60 clocks is required to execute the MIX & MIX process of 1 word.

As described above, in accordance with the fifth embodiment, the bit-block transfer process for MIX & MIX of 1 word, which has required 110 clocks in the above-mentioned conventional device, is reduced to 60 clocks, thereby making it possible to improve the processing speed of the bit-block transfer process, as compared with the above-mentioned conventional device. Moreover, since the work area on the memory 10, which has been required in the conventional case, is no longer required, it becomes possible to effectively use the memory 10 correspondingly.

The graphic accelerator according to a sixth embodiment of the present invention will now be explained. The sixth embodiment assumes a graphic accelerator which can improve the processing speed of the bit-block transfer process by changing the order of accesses in the Read and Write operations to and from the S area and D area.

If the row address is changed, are-activating sequence is required. Therefore, when a memory is provided as, for example, an SDRAM (Synchronous DRAM), in the processes in each of the first to fifth embodiments, it is necessary to design the processing sequence so as to minimize the change in row addresses.

In other words, provision is made so that once an access is made to the S area, the access within the S area is continuously maintained as long as possible. In the same manner, provision is made so that once an access is made to the D area, the access within the D area is continuously maintained as long as possible.

More specifically, among the five steps (1) to (5) in the first embodiment, the order of steps (4) and (5) is re-written as described below so that the number of the activating sequences to the SDRAM that are required during the process of 1 word is reduced to two. Here, in the first embodiment, the number of the activating sequences is four.

Next, an explanation will be given of the SWAP process by a graphic accelerator according to the sixth embodiment. (1) The control section 90 reads pixel data of 1 word among pixel data within the S area, and allows the S buffer 30 to store the resulting data.

(2) The control section 90 reads pixel data of 1 word among pixel data within the D area, and allows the D buffer 40 to store the resulting data.

(3) The data pass section 60 transfers the pixel data of the S buffer 30 to the WRT buffer 50, and also transfers the pixel data of the D buffer 40 to the WRT buffer 100.

(4) The control section 90 writes the pixel data of the WRT buffer 50 in the corresponding D area.

(5) The control section 90 writes the pixel data of the WRT buffer 100 in the corresponding S area.

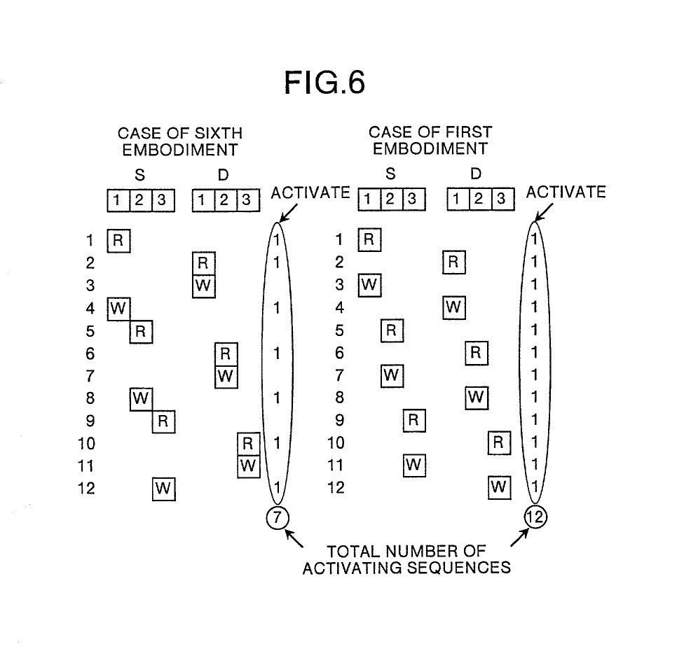

FIG. 6 shows the state of activating sequences when a bit-block transfer process for SWAP is carried out on the assumption that both of the S area and the D area are set to have 9 pixels (3 words) and 1 line in the sixth embodiment and the first embodiment.

In FIG. 6, S represents the S area, D represents the D area, “1”, “2” and “3” in the S area or the D area represent row addresses, each of “1 to 12” represents the number of accesses to the memory 10 (that is, the S area and the D area), R represents “Read”, and W represents “Write”.

For example, in the SWAP process up to the number of accesses from 1 to 3, the following processes are executed in the first embodiment:

First access: Read from S area

Second access: Read from D area

Third access: Write in S area.

In this case, activating sequences are required in the second and third accesses (see FIG. 6).

In contrast, in the sixth embodiment, the following processes are executed:

First access: Read from S area

Second access: Read from D area

Third access: Write in D area

In this case, although an activating sequence is required in the second access, no activating sequence is required in the third access (see FIG. 6).

As clearly shown in FIG. 6, the total number of the activating sequences is 7 in the sixth embodiment; in contrast, it is 12 in the first embodiment. In this manner, in comparison with the first embodiment, the sixth embodiment makes it possible to accelerate the SWAP process. Here, with respect to the above description, the same is true for the processes other than the SWAP process.

As described above, in accordance with the sixth embodiment, the respective processes are executed in the order of the reading process of pixel data from the source area, the reading process of pixel data from the destination area, the writing process of pixel data in the destination area and the writing process of pixel data in the source area; therefore, it is possible to reduce the number of activating sequences, and consequently to accelerate the bit-block transfer process such as the SWAP process.

As described above, in accordance with this invention, the pixel data within the source area is transferred to the third buffer, while the pixel data within the destination area is transferred to the fourth buffer, and the pixel data within the third buffer is written in the destination area, while the pixel data within the fourth buffer is written in the source area; therefore, it becomes possible to improve the processing speed of the bit-block transfer process for “exchanging pixel data between the source area and the destination area”, and since no work area for saving data is required, it is possible to effectively use the memory correspondingly.

In accordance with the next invention, the plotting data within the register is transferred to the third buffer, while the pixel data within the destination area is transferred to the fourth buffer, and the pixel data (plotting data) within the third buffer is written in the destination area, while the pixel data within the fourth buffer is written in the source area; therefore, it becomes possible to improve the processing speed of the bit-block transfer process for “painting the destination area with the plotting data, with the pixel data of the destination area being saved in the source area”.

In accordance with the next invention, the pixel data within the source area and the pixel data within the destination area are subjected to a predetermined calculation process, and the results of the calculation (pixel data) are transferred to the third buffer, and the pixel data within the destination area is transferred to the fourth buffer; then, the pixel data (the pixel data subjected to the predetermined calculation process) within the third buffer is written in the destination area, and the pixel data within the fourth buffer is written in the source area. Therefore, it becomes possible to improve the processing speed of the bit-block transfer process in which “the pixel data within the source area and the pixel data within the destination area are subjected to operations (for example, AND, OR, NOR, etc.), with the pixel data of the destination area being saved in the source area, and the results of the operations are written in the destination area”.

In accordance with the next invention, the plotting data (pixel data) within the register and the pixel data within the destination area are subjected to a predetermined calculation process, and the results of the calculation (pixel data) are transferred to the third buffer, and the pixel data within the destination area is transferred to the fourth buffer; then, the pixel data (the pixel data subjected to the predetermined calculation process) within the third buffer is written in the destination area, and the pixel data within the fourth buffer is written in the source area. Therefore, it becomes possible to improve the processing speed of the bit-block transfer process in which “the drawing data (pixel data) within the register and the pixel data within the destination area are subjected to operations (for example, AND, OR, NOR, etc.), with the pixel data of the destination area being saved in the source area, and the results of the operations are written in the destination area”.

In accordance with the next invention, the pixel data within the source area and the pixel data within the destination area are subjected to a predetermined calculation process, and the results of the calculation (pixel data) are transmitted to the third buffer and the fourth buffer; then, the pixel data (the pixel data subjected to the predetermined calculation process) within the third buffer is written in the destination area, and the pixel data (the pixel data subjected to the predetermined calculation process) within the fourth buffer is written in the source area. Therefore, it becomes possible to improve the processing speed of the bit-block transfer process in which “two kinds of operations (AND, OR, NOR, etc.) are executed by using the pixel data of the source area and the pixel data of the destination area, and the results of the operations are written in the source area and the destination area”, and since no work area for saving data is required, it is possible to effectively use the memory correspondingly.

In accordance with the next invention, the respective processes are carried out in the order of a reading process of data from the source area, a reading process of data from the destination area, a writing process of data to the destination area, and a writing process of data to the source area; therefore, it becomes possible to accelerate the bit-block transfer process such as, “for example, an exchange of pixel data”.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A graphic accelerator comprising:
a memory having a source area and a destination area;
a first buffer which holds pixel data read from said source area of said memory;
a second buffer which holds pixel data read from said destination area of said memory;
a third buffer which holds pixel data to be written into said memory;
a fourth buffer which holds pixel data to be written into said memory;
a reading unit which reads pixel data from said source area of said memory and makes said first buffer store the read pixel data, reads pixel data from said destination area of said memory makes said and makes second buffer store the read pixel data, in a unit of access to said memory;
a transfer unit which makes said first buffer to transfer the pixel data held in said first buffer to said third buffer, and makes said second buffer to transfer the pixel data held in said second buffer to said fourth buffer; and
a writing unit which writes the pixel data held in said fourth buffer in said source area of said memory and writes the pixel data held in said third buffer in said destination area of said memory.

2. The graphic accelerator according to claim 1, further comprising a register which stores plotting data,
wherein said reading unit reads pixel data from said destination area of said memory and makes said second buffer store the read pixel data in a unit of access to said memory, and said transfer unit reads data from the register to transfer the data to the third buffer and transfers the data held in the second buffer to the fourth buffer.

3. The graphic accelerator according to claim 1, wherein said transfer unit carries out a predetermined calculation process on the pixel data held in said first buffer and second buffer every corresponding pixel, and transfers the results of the calculation process to said third buffer, as well as transfers the pixel data held in said second buffer to said fourth buffer.

4. The graphic accelerator according to claim 2, wherein said transfer unit carries out a predetermined calculation process on the pixel data in said register and second buffer every corresponding pixel, and transfers the results of the calculation process to said third buffer, as well as transfers the pixel data held in said second buffer to said fourth buffer.

5. The graphic accelerator according to claim 1, wherein said transfer unit carries out a predetermined calculation process on the pixel data held in said first buffer and second buffer every corresponding pixel, and transfers the results of the calculation process to said third and fourth buffers.

6. The graphic accelerator according to claim 1, which, upon carrying out reading and writing processes on data at the same position in said source and destination areas of said memory, executes a sequence of processes in the order of a reading process of data from said source area, a reading process of data from said destination area, a writing process of data to said destination area, and a writing process of data to said source area.
